(19) United States
(12) Patent Application Publication
(10) Pub. No.: US 2025/0008315 A1
(43) Pub. Date: Jan. 2, 2025

(54) TECHNIQUE FOR SUBSCRIBER MONITORING IN A COMMUNICATION NETWORK

(71) Applicant: Telefonaktiebolaget LM Ericsson (publ), Stockholm (SE)

(72) Inventors: Attila BÁDER, Paty (HU); Gábor MAGYAR, Dunaharaszti (HU); László KOVÁCS, Martonvásár (HU)

(21) Appl. No.: 18/705,316

(22) PCT Filed: Nov. 3, 2021
(86) PCT No.: PCT/EP2021/080489

§ 371 Date: Apr. 26, 2024

(51) Int. Cl. H04W 8/20; H04L 41/142

(52) U.S. Cl. CPC H04W 8/20; H04L 41/142

(57) ABSTRACT

The present disclosure is directed to a technique for determining subscription identifiers for subscriber monitoring in a communication network. A plurality of data sets is provided and each data set associates, for a particular subscriber activity in the communication network, a subscription identifier with one or more activity-related attributes each having a dedicated attribute value. A method implementation includes processing the data sets to generate subscriber profiles, wherein each subscriber profile associates a subscription identifier with, for at least a first attribute, an attribute value or an attribute value distribution as derived from the data sets associated with the subscription identifier. The method further includes generating, from the subscriber profiles, attribute distribution statistics indicative of an occurrence of attribute values for at least the first attribute across the subscribers for which data sets have been processed.

### TECHNICAL FIELD

The present disclosure generally relates to monitoring of network traffic for the purpose of network analysis. In particular, a technique for determining subscription identifiers for subscriber monitoring in a communication network is presented. The technique may be implemented as a method, a computer program product, an apparatus or a system.

### BACKGROUND

Network management is an important feature of modern wired and wireless communication networks. Network management allows “troubleshooting” when quality of service issues or other network performance degradations are detected. Proper network management decisions are based on a continuous collection and analysis of a plethora of network-related events occurring locally within the managed communication network and reported by that network to a network management domain.

Quality of service experienced by the subscribers is the key differentiation factor for network service providers. Therefore, service quality assurance plays an important role in their network management decisions. Such decisions require fast and proper information about service quality degradations. Adequate service quality assurance requires monitoring the service quality, recognizing service quality issues, and then identifying and fixing their root causes—and all these actions must be done fast at a reasonable cost.

In subscription-based communication networks, network events are often reported to the network management domain on a subscriber level and for individual subscriber activities, so as to achieve a sufficiently high resolution for network analysis. For network management purposes, the network management domain may process the network events to derive subscriber activity-related data sets of a higher informational content. The data sets can include network event information in a possibly aggregated (e.g., averaged) and enriched form.

A given data set for a particular subscriber activity may associate a subscription identifier with one or more activity-related attributes, with each attribute having a dedicated attribute value. Typical attributes include a service type underlying the subscriber activity (e.g., voice call, video streaming, Web browsing, etc.), an activity duration, a type of terminal device involved (e.g., smartphone, tablet, etc.), a vendor of the involved terminal device vendor (e.g., Apple, Huawei, Samsung, etc.), an identifier of a serving cell, a measured key performance indicator (KPI) in terms of service quality (e.g., Web page access time, video stall time ratio, session setup time, etc.), and so on. A particular attribute will assume a dedicated attribute value for a given subscriber activity. The attribute value can be a numerical value (e.g., duration of activity=10.34 sec) or a non-numerical nominal value (e.g., service type=voice call).

Traditional network event collection techniques are based on passive probing of, or pre-configured event reporting by, different network functions of a communication network. In the case of certain wireless communication networks, those network functions may stretch over different network domains, such as a radio access network domain and a core network domain.

While the volume of reported network events is already significant in wireless communication networks of the 4th Generation (4G), the event reporting volume is expected to drastically increase with the ongoing deployment of 5th Generation (5G) networks (also called New Radio, NR, networks). This increase is partly due to higher numbers of terminal devices because of new terminal device types, including Internet of Things (IoT) devices, and partly the result of new service types that will become available in 5G networks.

Short reaction times in network management are desirable and require real-time analytics solutions, which in turn consume considerable processing and storage resources. As an example, it is expected that event collection by user plane probing in a 5G network will per core network site easily result in several terabit of user plane traffic that needs to be processed and evaluated in real time. A similar situation will arise in the radio access network domain as a result of the increasing numbers of terminal devices and network cells. Evidently, significant processing and database capacities, and also significant electric power, will thus be consumed for network monitoring and network analysis.

Attempts have been made to reduce the reported volume of network events and, thus, the monitoring footprint in the communication network. For example, it has been suggested to apply random event sampling techniques to reduce the amount of data that needs to be collected and analyzed for network management purposes. Random sampling of network events has in some cases been found to reduce the efficiency of detecting network anomalies as it cannot be ensured that, for example, problematic communication sessions are not “filtered out” in view of the applied randomness. On the other hand, a continuous and full traffic coverage by network monitoring is—for the reasons set out above—likewise problematic in certain cases. It has further been found that fixed random sampling rates will not produce enough data in off-peak hours, while not all network functions may support dynamic sampling rates.

Other footprint reduction approaches include subscriber filtering, spotlight analytics and sweeping. Subscriber filtering is used for monitoring a limited number of subscribers (e.g., VIP subscribers). It has been found that consistent subscriber filtering across different network functions and domains can only be applied to a limited number of subscribers, e.g., 10% of subscribers, at a time. For this reason, conventional subscriber filtering does often not produce enough data for an efficient troubleshooting. Spotlight analytics is used to focus on a smaller geographical or network area, or to focus on specific problems. However, spotlight analytics is not compatible with typically network-wide monitoring requirements. Spotlight monitoring can be combined with sweeping to cover multiple areas one by one. The drawback of this solution is that the collected network events of areas (except the actual one) are old and not suitable for real-time analytics.

### SUMMARY

Accordingly, there is a need for a network monitoring technique that avoids one more of the above, or other, drawbacks. As an example, the technique shall be resource efficient while enabling a reliable troubleshooting.

A first aspect is directed to a method of determining subscription identifiers for subscriber monitoring in a communication network. A plurality of data sets is provided and each data set associates, for a particular subscriber activity in the communication network, a subscription identifier with one or more activity-related attributes each having a dedicated attribute value. The method comprises processing the data sets to generate subscriber profiles, wherein each subscriber profile associates a subscription identifier with, for at least a first attribute, an attribute value or an attribute value distribution as derived from the data sets associated with the subscription identifier. The method further comprises generating, from the subscriber profiles, attribute distribution statistics indicative of an occurrence of attribute values for at least the first attribute across the subscribers for which data sets have been processed. Further, the method comprises assembling, based on the distribution statistics and the subscriber pro-files, a list of subscription identifiers for which subscriber activities are to be monitored for a network analysis relating to at least the first attribute.

The list of subscription identifiers may comprise at least two sub-lists of subscription identifiers, wherein each sub-list is associated with a dedicated attribute value of at least the first attribute. As such, the method may comprise selecting, for a particular attribute value of at least the first attribute, the subscriber profiles matching that attribute value, wherein the respective sub-list of subscription identifiers is populated by at least some of the subscription identifiers associated with the selected subscriber profiles.

A cardinal number of the populated sub-list of subscription identifiers is less than a cardinal number of the selected subscriber profiles. In this context, the method may comprise executing a random-based population algorithm to populate the sub-list of subscription identifiers such that the cardinal number of the populated sub-list is less than the cardinal number of the selected subscriber profiles.

Each sub-list may have a respective cardinal number that depends on a relative or absolute occurrence of the respective attribute value as defined in the attribute distribution statistics. The cardinal number of a given sub-list may be proportional to the relative or absolute occurrence of the respective attribute value as defined in the attribute distribution statistics. The cardinal number of a given sub-list may be relatively higher if the relative or absolute occurrence of the respective attribute value as defined in the at-tribute distribution statistics is relatively lower. The cardinal number of a given sub-list may depend on a statistical measure derived from the attribute distribution statistics. The statistical measure may be a standard deviation. The cardinal number of a given sub-list may be inversely proportional to the relative or absolute occurrence of the respective attribute value. In some cases, each sub-list may have the same cardinal number.

One or more of the subscriber profiles may associate a single attribute value with at least the first attribute. One or more of the subscriber profiles may associate two or more different attribute values with at least the first attribute. In the latter case, the method may comprise selecting one of the two or more different attribute values for control-ling membership of a respective subscription identifier to a single sub-list. The attribute value having a maximum occurrence within the attribute value distribution of the associated subscriber profile may be selected. Membership of a respective subscription identifier to two or more different sub-lists may be controlled based on the attribute value distribution in the associated subscriber profile.

At least some of the subscriber profiles may associate the respective subscription identifier with a first attribute value, or a first attribute value distribution, for the first attribute and a second attribute value, or a second at-tribute value distribution, for the second attribute. In such a case, the attribute distribution statistics may be indicative of a combined occurrence of the respective attribute value for at least the first attribute and the second attribute across the subscribers for which data sets have been processed. Each sub-list of subscription identifiers may be associated with a dedicated first attribute value of the first attribute and dedicated second attribute value of the second attribute.

The data sets may be obtained for more than 50%, and optionally all of the subscriber activities in the communication network during a particular period of time (e.g., in terms of more than 50%, and optionally all of the subscribers). The data sets may be indicative of subscriber activities that have been monitored over successive periods of time, wherein the subscriber activities of different sets of subscription identifiers are monitored in different periods of time. The different sets of subscription identifiers may be defined by a sampling algorithm receiving subscription identifiers as input and yielding a monitoring decision for a given period of time as output. The sampling algorithm may be configured to apply a hash function.

The method may comprise obtaining further data sets based on monitoring for the subscription identifiers included in the list updating the subscriber profiles based on the obtained further data sets.

The subscription profiles and the distribution statistics may be generated in a learning phase, and wherein the list assembling step is performed during, or in preparation of, a subsequent operational phase. The operational phase may comprise performing network monitoring based on the list of subscription identifiers.

The list assembling step may be performed in response to a network analytics request pertaining to at least the first attribute. The network analytics request may include an indication of at least the first attribute, or one or more associated attribute values, and, optionally, an indication of a type of measurement to be performed in the context of network monitoring based on the list of subscription identifiers.

The list assembling step may performed by a service operation center.

The attribute values may be comprised by a set of discrete attribute values. The attributes may include one or more of: a terminal device type; an activity duration; a geographical location of the terminal device; an activity type, in particular a service type; a service quality-related parameter.

Also provided is a computer program product comprising program code portions to perform the steps of any of the preceding claims when the computer program product is executed by one or more processors. The computer program product may be stored on a computer readable recording medium.

Another aspect is directed to an apparatus for determining subscription identifiers for subscriber monitoring in a communication network. A plurality of data sets is provided and each data set associates, for a particular subscriber activity in the communication network, a subscription identifier with one or more activity-related attributes each having a dedicated attribute value. The apparatus is configured to process the data sets to generate subscriber profiles, wherein each sub-scriber profile associates a subscription identifier with, for at least one attribute, an attribute value or an attribute value distribution as derived from the data sets associated with the subscription identifier. The apparatus is further configured to generate, from the subscriber profiles, attribute distribution statistics indicative of an occurrence of attribute values for the at least one attribute across the subscribers for which data sets have been processed and to assemble, based on the distribution statistics and the subscriber pro-files, a list of subscription identifiers for which subscriber activities are to be monitored for a network analysis relating to at least the first attribute.

The apparatus may be configured to perform the steps of any of the method aspects described herein.

Also provided is a network monitoring system comprising the apparatus presented herein and network monitoring infrastructure in the communication network, the network monitoring infrastructure configured to perform subscriber monitoring based on the list of subscription identifiers. The network monitoring infrastructure may comprise hardware probes, software probes or combinations thereof.

### BRIEF DESCRIPTION OF THE DRAWINGS

Further aspects, details and advantages of the present disclosure will become apparent from the detailed description of exemplary embodiments below and from the drawings, wherein:

FIG. 1 is a diagram illustrating a network system embodiment of the present disclosure;

FIGS. 2 & 3 are block diagrams illustrating embodiments of a subscription identifier determination apparatus in accordance with the present disclosure;

FIG. 4 is a flow diagram of a method embodiment of the present disclosure;

FIG. 5 schematically illustrates a collection of activity-related data sets in accordance with the present disclosure;

FIG. 6 schematically illustrates a collection of subscriber profiles in accordance with the present disclosure; and

FIG. 7 schematically illustrates a collection of attribute distribution statistics in accordance with the present disclosure.

### DETAILED DESCRIPTION

In the following description, for purposes of explanation and not limitation, specific details are set forth in order to provide a thorough understanding of the present disclosure. It will be apparent to one skilled in the art that the present disclosure may be practiced in other embodiments that depart from these specific details.

While, for example, some embodiments of the following description focus on an exemplary network configuration in accordance with 5G specifications, the present disclosure is not limited in this regard. In particular, the present disclosure could also be implemented in other wired or wireless communication networks (e.g., according to 4G specifications).

Those skilled in the art will further appreciate that the steps, services and functions explained herein may be implemented using individual hardware circuits, using software functioning in conjunction with a programmed microprocessor or general purpose computer, using one or more application specific integrated circuits (ASICs) and/or using one or more digital signal processors (DSP). It will also be appreciated that when the present disclosure is described in terms of a method, it may also be embodied in one or more processors and one or more memories coupled to the one or more processors, wherein the one or more memories store one or more computer programs that perform the steps, services and functions disclosed herein when executed by one or more processors.

In the following description of exemplary embodiments, the same reference numerals denote the same or similar components.

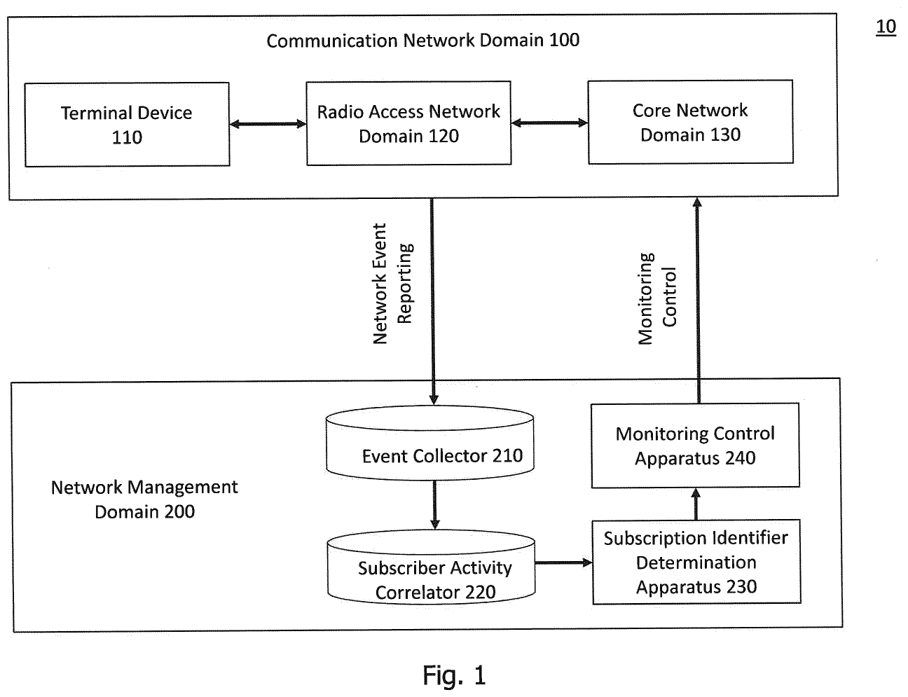

FIG. 1 illustrates an embodiment of a network system 10 in which the present disclosure can be implemented. The system 10 comprises a communication network domain 100 configured to provide communication services and to monitor network traffic and related events. The system 10 further comprises a network management (NM) domain 200 configured to control network traffic monitoring in the communication network domain 200 and to analyze the monitoring results.

In the embodiment of FIG. 1, the communication network to be monitored is configured as a cellular mobile communication network. As such, the communication network domain 100 comprises one or more wireless terminal devices 110, a radio network access (RAN) domain 120 and a core network (CN) domain 130. The RAN domain 120 and the CN domain 130 each comprises a large number of network functions (NFs). A particular NF may be a software entity (e.g., implemented using cloud computing resources), a stand-alone hardware entity (e.g., in the form a network node), or a combination thereof. In some variants, the NFs may conform to the definitions of “network functions” as standardized by the 3^{rd} Generation Partnership Project (3GPP) in its 5G specifications, but in other variants (e.g., in 4G implementations) this may not be the case. Exemplary 5G NFs of the CN domain 130 include a user plane function (UPF), a session management function (SMF), an access and mobility management function (AMF), and so on. The RAN domain 129 can be configured to include base stations conforming to one or both of 4G and 5G specifications, WiFi access points, and so on.

The entities in the communication network domain 100 are configured to report information on network events to the NM domain 200. In the context of the present disclosure, network events are to be construed broadly. Network events generally characterize what is happening in the communication network domain 200, such as session initiation or termination, the status of an ongoing session, transmission of a certain amount of data, and so on. So called key performance indicators (KPIs), usually numeric values, can be reported as events as such or as characteristic parameters of one or more events, such as session initiation time, ratio of unsuccessful session initiations, the amount of transmitted bytes over a given amount of time, and so on. A network event can be reported when it is locally detected at a dedicated monitoring site (e.g., a dedicated NF) or in response to probing. The network events can be standardized (e.g., 4G or 5G) signalling events or vendor-specific events (of, e.g., a network node acting as NF). Event probing may be performed in the communication network domain 100 to capture the events at a network interface, or to capture user plane traffic, sample it and generate user plane traffic metrics that are to be reported as one or more network events.

KPIs and other network event information can be calculated from, or attributed to, one or multiple network events. As an example, a handover failure can be reported in, or as, a network event. Exemplary KPIs calculated from this event, or from multiple such events, locally in the communication network domain 100, or centrally in the NM domain 200, are a number of handover failures or a ratio of the handover failures and the total handovers in a certain period of time. As another example, an NF user plane probe may report a throughput event every 5 s in a dedicated event report. An average throughput KPI can be calculated locally, or centrally, as the average of these throughputs for 1 min, and a maximum throughput KPI can be calculated locally, or centrally, as the maximum of the reported throughputs in 1 min.

With continued reference to FIG. 1, the NM domain 200 comprises an event collector 210 configured to receive and, optionally, store and pre-process network event information resulting from network monitoring in the communication network domain 100. The event collector 210 may include corresponding interfaces, processing capabilities and a database for storing the (optionally pre-processed) network event information.

The NM domain 200 further comprises a subscriber activity correlator 220 configured to provide data sets relating to subscriber activities. As will be explained in greater detail below, each such data set associates, for a particular subscriber activity in the communication network domain 100, a subscription identifier with one or more activity-related attributes, wherein each attribute has a dedicated attribute value. Such attributes may include, for example, one or more of a terminal type, a terminal identifier, a subscriber activity start and/or duration, a geographical location of the terminal device (e.g., a cell identifier or geographical coordinates), an activity (e.g., service) type, a service quality-related parameter (e.g., a particular KPI), a vendor of the terminal device, a vendor of RAN infrastructure involved in the subscriber-activity, and so on.

In some variants, the subscriber activity correlator 220 is configured to process the (optionally pre-processed) network event information as provided by the event collector 210 and to generate the data sets from the network event information thus processed. The subscriber activity correlator 220 may include corresponding interfaces, processing capabilities and a database for storing the data sets.

In an exemplary realization, the subscriber activity correlator 220 correlates different attributes (with the associated attribute values) from possibly different sources to generate the subscriber activity-related data sets. Such sources of information include the network events, but also network components storing subscription-related information (e.g., relating to subscription type, etc.), network components configured to aggregate information reported as network events (such as the event collector 210), network components configured to calculate KPIs, and so on. Each subscriber activity-related data set may related to one dedicated network activity (e.g., a dedicated service usage transaction) of a dedicated subscriber.

In some variants, the event collector 210 and the subscriber activity correlator 220 are integrated into a single entity. In other variants, the event collector 210 may be omitted and the network event information from the communication network domain 100 may directly be received and processed by the subscriber activity correlator 220.

As illustrated in FIG. 1, the NM domain 200 further comprises a subscription identifier determination apparatus 230 and a monitoring control apparatus 240. The subscription identifier determination apparatus 230 is configured to assemble, based on the data sets provided by the subscriber activity correlator 220, a list of subscription identifiers for which subscriber activities (e.g., particular service usages) are to be monitored. This monitoring is performed so as to enable an analysis of the communication network domain 100 in regard to one or more attributes and, optionally, one or more associated KPIs.

The monitoring control apparatus 240 is configured to receive the list of subscription identifiers from the subscription identifier determination apparatus 230 and to provide corresponding network monitoring control instructions to the communication network domain 100. In some variants, the subscription identifier determination apparatus 230 and the monitoring control apparatus 240 are integrated into a single entity.

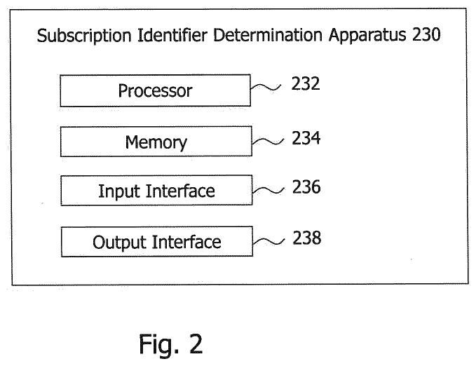

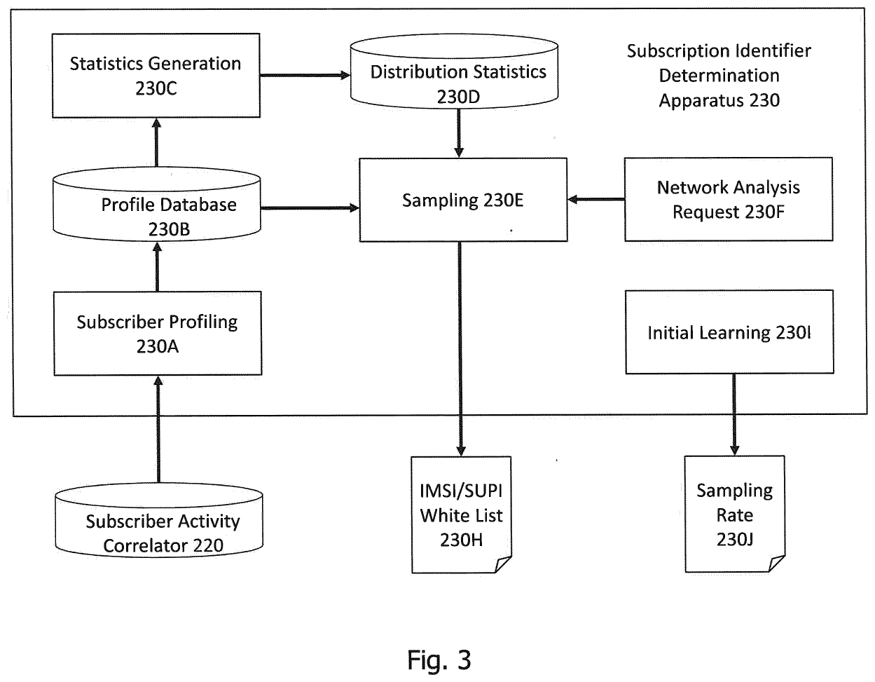

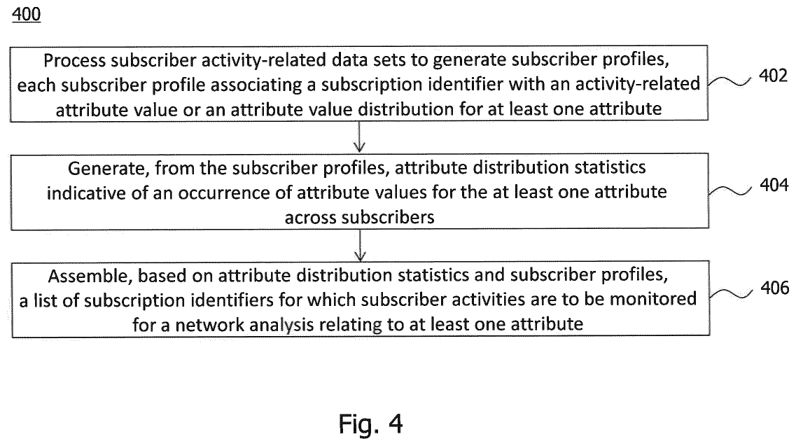

In the following, embodiments of the subscription identifier determination apparatus 230 of FIG. 1 will be described with reference to FIGS. 2 and 3, and operational details of the subscription identifier determination apparatus 230 will be described with reference to a method embodiment as illustrated in flow diagram 400 of FIG. 4.

In the apparatus embodiment illustrated in FIG. 2, the subscription identifier determination apparatus 230 comprises a processor 232 and a memory 234 coupled to the processor 232. The memory 234 stores program code (e.g., in the form of a set of instructions) that controls operation of the processor 232 so that the subscription identifier determination apparatus 230 is operative to perform any of the functional and operational aspects presented herein (see, e.g., FIGS. 3 and 4). As understood herein, a processor, such as processor 232, may be implemented using any processing circuitry, and is not limited to, for example, a single processing core, but may also have a distributed topology (e.g., using cloud computing resources).

The subscription identifier determination apparatus 230 further comprises at least an input interface 236 and an output interface 238. The interfaces 236, 238 are configured for communication with the subscriber activity correlator 220 on the one hand and the monitoring control apparatus 240 (or directly with communication network domain 100, e.g., individual NFs therein) on the other hand.

Referring to the functional representation of the subscription identifier determination apparatus 230 of FIG. 3 and the flow diagram 400 of FIG. 4, operation of the subscription identifier determination apparatus 230 will now be described in more detail.

In step 402 of FIG. 4, the subscription identifier determination apparatus 230 processes the data sets provided by the subscriber activity correlator 220 to generate subscriber profiles. This procedure is also called subscriber profiling (see function 230A in FIG. 3).

As described previously, the subscriber activity correlator 220 provides (e.g., stores) a plurality of data sets relating to individual subscriber activities in the communication network domain 100. Each data set associates, for a particular subscriber activity in the communication network domain 100, a subscription identifier with one or more activity-related attributes, and each attribute has a dedicated attribute value. In some variants, the data sets have been generated by the subscriber activity correlator 220 on the basis of the network events collected by the event collector 210 and possibly further information (i.e., attributes with associated attribute values) pertaining to a particular subscriber activity. Such further information can be used to enrich the information gathered as network events. As an example, two or more network events reported by the communication network domain 100 may be correlated by the subscriber activity correlator 220 to derive a particular data set. Such correlation can be performed using one or more items of correlation information included in the network events, such as time stamps, subscription identifiers, session identifiers, and so on.

The data sets may be obtained for more than 50%, and optionally all of the subscriber activities in the communication network domain 100 during a particular period of time. As an example, the data sets may reflect all, or at least a substantial portion of more than 50% of all subscribers of an operator of the communication network domain 100. It can thus be ensured that any subsequent subscriber profiling and statistics generation operations are highly accurate.

Each attribute value in a data set provided by the subscriber activity correlator 220 can be considered to constitute a “dimension”, and each possible attribute value of a given attribute can be considered to constitute a “stratum” of that “dimension”. The attribute values may be discrete values. In case the underlying network event information, or other attribute values information, is non-discrete, “binning” may be performed to map dedicated numerical ranges on dedicated discrete values (i.e., dedicated “bins”). Of course, there exist alternative “discretization” approaches that could be used as well.

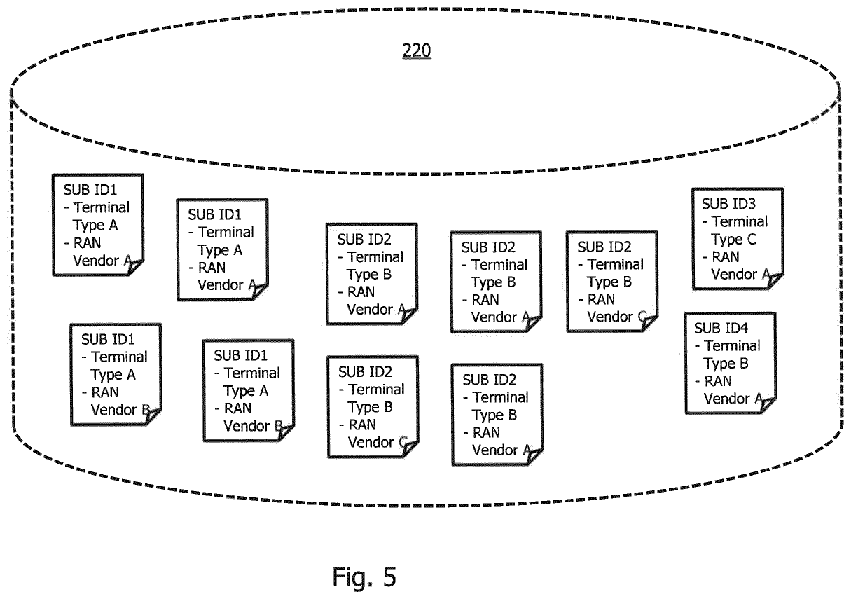

FIG. 5 illustrates in a schematic manner possible contents of the data sets as provided by the subscriber activity correlator 220 to the subscription identifier determination apparatus 230 for individual subscriber activities. In the example illustrated in FIG. 5, each data set correlates a subscription identifier (here: SUB ID1 to SUB ID4) with a first attribute (Terminal Type) and a second attribute (RAN Vendor). In practice, each data set may comprise dozens of attributes. The subscription identifiers in the data sets can be subscription permanent identifiers (SUPIs), international mobile subscriber identifiers (IMSIs), any other subscription identifier type, or combinations thereof. The attribute “Terminal Type” can assume different attribute values, such as Terminal Type A (e.g., tablet), Terminal Type B (e.g., smartphone), Terminal Type C (e.g., wearable device) and Terminal Type D (e.g., IoT device). In a similar manner, attribute “RAN Vendor” likewise can assume different attribute values, such as RAN Vendor A (e.g., Ericsson), RAN Vendor B (e.g., Nokia) and RAN Vendor C (e.g., Huawei).

It will be appreciated that each data set may comprise multiple further attributes with associated attribute values, or may comprise only a single attribute with an associated attribute value. Moreover, one or more attributes may also have been derived by enrichment or other pre-processing operations. Enrichment may comprise looking up supplemental information for integration in a particular data set, for example based on the content of one or more network events.

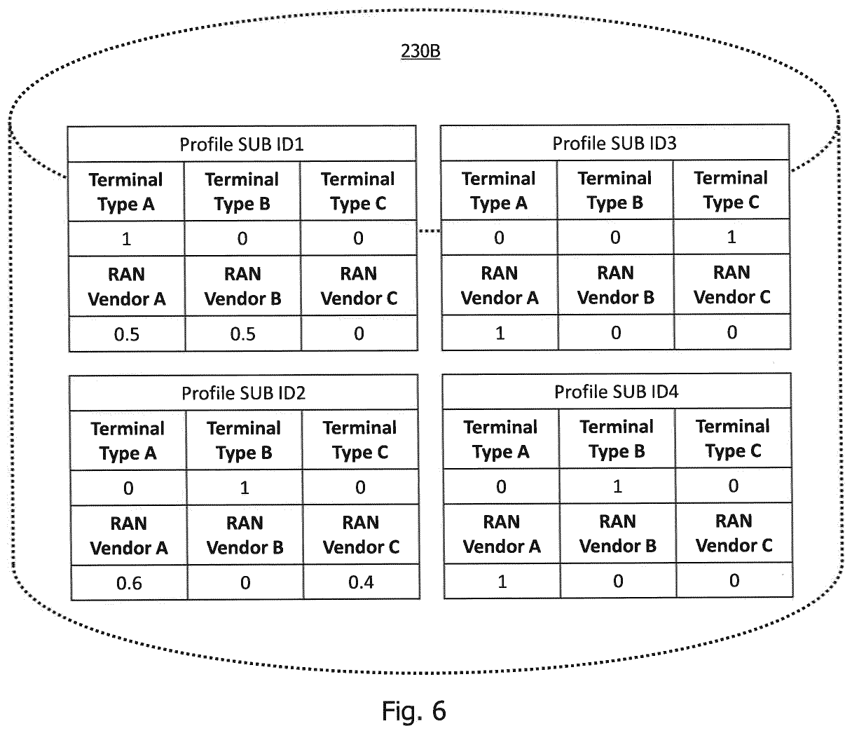

A particular subscriber profile generated by the subscription identifier determination apparatus 230 in step 402 associates a particular subscription identifier with, for at least one attribute, an attribute value or an attribute value distribution as derived from the data sets associated with the subscription identifier. FIG. 6 illustrates exemplary subscriber profiles as generated from the exemplary data sets illustrated in FIG. 5. As illustrated in FIG. 3, the subscriber profiles may be stored in a subscriber profile database 230B.

As becomes apparent from the subscriber profile examples in FIG. 6, the subscriber profile for SUB ID1 indicates that the attribute “Terminal Type” has the attribute value “A”, while the attribute “RAN Vendor” as a certain attribute value distribution with that attribute assuming the value “RAN Vendor A” in 50% of all cases and the value “RAN Vendor B” in the remaining 50% of all cases. Similar considerations apply to the remaining subscriber profiles for SUB ID2 to SUB ID4

Referring now to step 402 of FIG. 4, the method further comprises generating, from the subscriber profiles stored in the subscriber profile database 230B, attribute distribution statistics indicative of an occurrence of attribute values for one or more attribute across the subscribers for which data sets have been processed in step 402. Step 404 is executed by the statistics generation function 230C in FIG. 3. FIG. 3 also illustrates that the attribute distribution statistics generated in step 404 may be stored in a distribution statistics database 230D.

The attribute distribution statistics generated in step 404 may be indicative of how many subscribers are having a particular attribute value for a given attribute in their subscriber profile. In some implementations, the attribute distribution statistics can take the form of one-, two- or higher-dimensional tables.

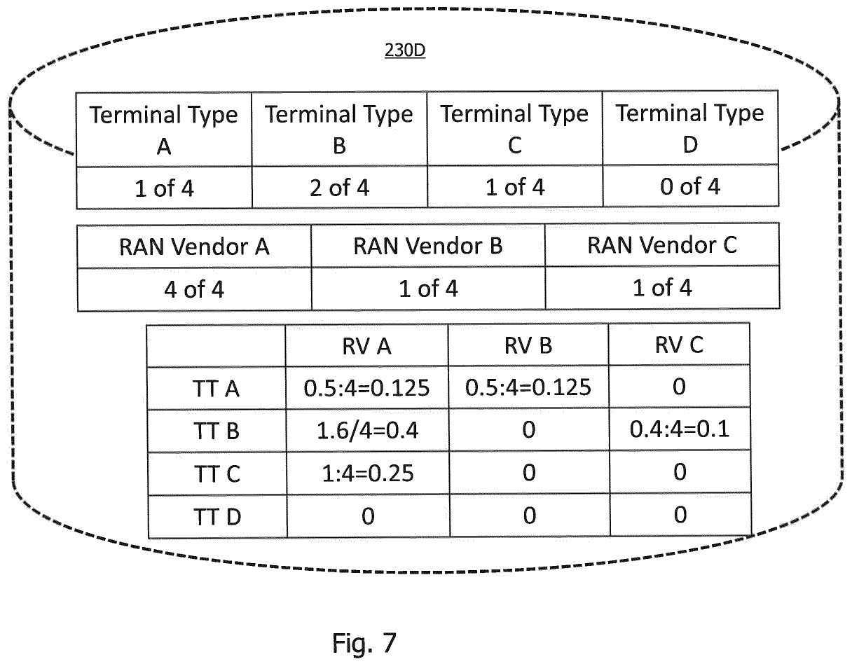

FIG. 7 illustrates exemplary one-and two-dimensional attribute distribution statistics tables that have been derived based on the exemplary subscriber profiles of FIG. 6. There is a one-dimensional table for each of the two attributes “Terminal Type” and “RAN Vendor”. Moreover, there is a two-dimensional table with more granular attribute distribution statistics across the two “dimensions” “Terminal Type” and “RAN Vendor”.

The method continues, in step 406 of FIG. 4, with assembling, based on the attribute distribution statistics (see, e.g., FIG. 7) and the subscriber profiles (see, e.g., FIG. 6), a list of subscription identifiers for which subscriber activities are to be monitored. In some implementations, the list of subscription identifiers is assembled responsive to a network analysis request indicative of one or more of the attributes, or associated attribute values, for which attribute distribution statistics have been generated in step 404 and for which a network analysis is requested. The list assembling step 406 may be performed by a service operation center (SOC). The SOC may be operated by an operator of the communication network domain 100. In some variants, the entire NM domain 200 is operated by the SOC (e.g., as part of a customer experience management, CEM, solution). In such variants, steps 402, 404 and 406 may all be performed by the SOC.

With reference to FIG. 3, a sampling function 230E of the subscription identifier determination apparatus 230 may be configured to perform at least a part of the list assembling step 406. The list assembling step 406 may include sampling (i.e., selecting) subscriber profiles as generated in step 402 dependent on the attribute distribution statistics that have been generated in step 404 to define a population of subscribers (identified by their subscription identifiers) to be monitored for the network analysis request.

As illustrated in FIG. 3, the sampling function 230E is triggered by receipt of a network analysis request from a corresponding function 230F. The network analysis request may have been input by a user or may have been created automatically in response to a detected service degradation or other malfunction. As explained above, the network analysis request may be indicative of one or more attributes for which a network analysis is requested. The network analysis request triggers the sampling function 230E to sample the subscriber profiles as stored in the subscriber profile database 230B. The sampling function 230E may be configured to apply a random sampling algorithm in this context. The sampling is performed under control of information retrieved (in accordance with the attribute(s) and, optionally, further information as included in the network analysis request) from the distribution statistics database 230D and results in a list 230H of subscription identifiers (e.g., SUPIs and/or IMSIs). The list 230H of subscription identifiers can be considered to constitute a “white” list as it indicates the subscribers to be monitored (and not the subscribers to be excluded from monitoring).

With continued reference to FIG. 3, the (optionally filtered) white list 230H of subscription identifiers will be output by the subscription identifier determination apparatus 230 to the monitoring control apparatus 240 (see FIG. 1). The monitoring control apparatus 240 will then, based on the list 230H of subscription identifiers, generate monitoring control instructions for (e.g., selected NFs of) the communication network domain 100. The control instructions will configure network monitoring infrastructure (e.g., user plane probes) in the communication network domain 100 to monitor and report to the NM domain 200 network events associated with the subscription identifiers on the list 230H. The reported network events may then be evaluated in the NM domain 200 to provide a response to the network analysis request.

In some variants, the network analysis request further (i.e., in addition to one or more attributes or associated attribute values) specifies one or more specific parameters of interest (e.g., a KPI, such as a handover failure rate). Such one or more parameters may also be communicated to the monitoring control apparatus 240 (e.g., by the subscription identifier determination apparatus 230) so that the monitoring control apparatus 240 can appropriately configure the communication network domain 100 to specifically report as network events, for the subscription identifiers on the list 230H, the one or more parameters of interest (or one or more parameters that allow to calculate the one or more parameters of interest in the NM domain 200).

In some implementations, further data sets are obtained by the subscriber activity correlator 220 of FIG. 1 based on subscriber activities monitored for the subscription identifiers included in the list assembled in step 406 of FIG. 4. The subscriber profiles in the subscriber profile database 230B of FIG. 3 may then continuously be updated based on the obtained further data sets, and the subscriber profiling, attribute distribution statistics generation and list assembling steps 402, 404, 406 may be repeated (e.g., in a cyclic manner or dependent on the number of updates). In some variants, the updating is limited to the particular subscriber profiles that are associated with the subscription identifiers on the list assembled in step 406 (i.e., to the subscribers currently being monitored to answer a specific network analysis request). The attribute distribution statistics may be updated either periodically based on the updated subscriber profiles or when the changes in the subscriber profiles exceed a certain threshold.

It has been found that compared to traditional sampling approaches such as random sampling, applying the “subscriber profiling” step 402 of FIG. 4 (see function 230A of FIG. 3) in combination with the evaluation of associated statistics information (see step 404 of FIG. 4 and function 230C of FIG. 3) reduces the total number of subscribers to be monitored for answering a particular network analysis request. Simple random IMSI/SUPI-based sampling without profiling, on the other hand, may select randomly a certain number, e.g., 10%, of subscribers, collects network events for those subscribers, calculates associated KPIs and answers a network analysis request based on this “10% data”. There can be two problems with this solution: the “10% data” is still huge in terms of the overall amount of associated data processing and storing requirements (i.e., the monitoring footprint) in the communication network domain 100, while it can happen at the same time that the reported network events are not sufficient (e.g., to monitor a KPI per cell to investigate an RAN issue).

Subscriber profiling as presented herein is one step to address such issues: it allows to select those subscribers (in terms of their associated subscription identifiers) who are particularly interesting for a given network analysis request (e.g., a particular SOC-related analytics question). Assume that that an operator of the communication network domain 100 wants to investigate a handover issue related to a specific terminal type (e.g., wearable device) in comparison to other terminal types (e.g., smartphones). Since wearable communication devices such as smartwatches are still comparatively seldom, random sampling will not yield enough information on handovers relating to wearable devices. This issue can be addressed using the information gathered in the subscriber profiling step 402 in combination with the information derivable from the distribution statistics generated in step 404.

In the above example, the attribute of interest for network analytics will be “Terminal Type” and the attribute values of interest will be “wearable device” and “smartphone”, i.e., Terminal Types C and B, respectively, in the example of FIGS. 5 to 7 (it will be appreciated that in practice, there may, e.g., be hundreds of subscriber profiles with the attribute value “wearable device” and ten thousands of subscriber profiles with the attribute value “smartphone”). In will in the present example be assumed that there is no overlap between “smartphone subscriptions” and “wearable device subscriptions”, meaning that there exist distinct sets of subscription identifiers. Other cases with “overlapping” attribute values can also be handled and will be discussed below.

Initially (e.g., in a first sub-step of step 406), a first sub-set of subscriber profiles matching the attribute value “wearable device” and a second sub-set of subscriber profiles matching the attribute value “smartphone” are selected. Then (e.g., in a second sub-step of step 406), a dedicated first sub-list of subscription identifiers is populated, or sampled, from the subscription identifiers in the first sub-set of subscriber profiles and a dedicated second sub-list of subscription identifiers is populated, or sampled, from the subscription identifiers in the second sub-set of subscriber profiles (see sampling function 230E in FIG. 3). The resulting two sub-lists are joined, or merged, to assemble the “final” list of subscription identifiers (e.g., in a third substep of step of step 406). The resulting list of subscription identifiers may then be output by the subscription identifier determination apparatus 230 to the monitoring control apparatus 240, as explained above, together with an indication that (in the present example) an handover-related KPI is to be reported by the communication network domain 100 for the listed subscription identifiers.

As explained initially, the number of subscription identifiers (i.e., subscribers) to be monitored is to be kept low. For this reason the populating, or sampling, operation in the third sub-step will be performed such that a cardinal number of each populated sub-list of subscription identifiers is less than a cardinal number of all matching subscriber profiles selected in the selection sub-step. In this regard, a random-based populating, or sampling, algorithm can be executed in the second sub-step to populate each sub-list of subscription identifiers such that the cardinal number of the populated sub-list is less than the cardinal number of the selected subscriber profiles. This algorithm may be controlled by the attribute distribution statistics in one of several ways. As an example, each sub-list may have a respective cardinal number that depends on a relative or absolute occurrence of the respective attribute value as defined in the attribute distribution statistics. As understood herein, a relative occurrence refers to a sub-set of selected attribute values (e.g., among “wearable devices” and “smartphones” in the above example), whereas an absolute occurrence refers to an occurrence across all possible attribute values (e.g., including “IoT devices” and “tablets” in the above example) and, thus, across all subscriber profiles.

In some implementations, the cardinal number of a given sub-list is proportional to the relative or absolute occurrence of the respective attribute value as defined in the attribute distribution statistics. This means in the above example that if smartphone subscriptions are a ten thousand time more numerous than wearable device subscriptions (assuming that both subscription types are mutually exclusive), the sub-list with the subscription identifiers for the attribute value “smartphone” will include ten thousand entries for each entry on the sub-list with the subscription identifiers for the attribute value “wearable device”.

In some implementations, such a “proportional” sampling approach does not give enough samples for rare attribute values (such as “wearable device” in the present example). Thus, alternatively, each sub-list may have the same cardinal number of, for example, 1.000 subscription identifiers.

As a still further variant, the cardinal number of a given sub-list may be relatively higher if the relative or absolute occurrence of the respective attribute value as defined in the attribute distribution statistics is relatively lower, which can be realized by “oversampling” for small or rare attribute values. In the “wearable device”/“smartphone” example, this over-sampling can, for example, realized by sublists having the same cardinal number.

In another implementation, the cardinal number of a given sub-list is inversely proportional to the relative or absolute occurrence of the respective attribute value. In a still further variant, the cardinal number of a given sub-list depends on a statistical measure derived from the attribute distribution statistics. The statistical measure can be a standard deviation of the attribute values of a given attribute. This statistics-based population approach is based on the insight that in case of homogenous attribute values (as indicated by the statistical measure), a comparatively smaller cardinal number of a certain sub-list does not negatively impact the overall precision.

One or more of the subscriber profiles may associate a single attribute value with a certain attribute (see, e.g., attribute “Terminal Type” for subscriber profile SUB ID2 in FIG. 6). Of course, one or more subscriber profiles could also associate two or more different attribute values with a certain attribute (see, e.g., attribute “RAN Vendor” for subscriber profile SUB ID2 in FIG. 6). In the latter cases, one of the two or more different attribute values may be selected for controlling membership of a subscription identifier (of the associated subscriber profile) to a single sub-list. As an example, the attribute value having a maximum occurrence within the attribute value distribution of the associated subscriber profile can be selected (e.g., attribute value “RAN Vendor A” for subscriber profile SUB ID2 in FIG. 6, so that SUB ID2 will be on the sub-list associated with “RAN Vendor A”). Alternatively, membership of a subscription identifier to two or more different sub-lists may be controlled based on the attribute value distribution in the associated subscriber profile. This approach may include associating a corresponding weighting factor with the corresponding membership, which may then, e.g., be used to “discount” certain KPIs reported for the subscription identifier, or used otherwise. In the example of FIG. 6, SUB ID2 may enter the sub-list associated with “RAN Vendor A” with a weighting factor of 0.6 and the sub-list associated with “RAN Vendor C” with a weighting factor of 0.4.

At least some of the subscriber profiles may associate the respective subscription identifier with a first attribute value, or a first attribute value distribution, for a first attribute and a second attribute value, or a second attribute value distribution, for a second attribute (see, e.g., attributes “Terminal Type” and “RAN Vendor” for the subscriber profiles in FIG. 6). In such a case, the attribute distribution statistics may be indicative of a combined occurrence of the respective attribute value for at least the first attribute and the second attribute across the subscribers for which data sets have been processed (see, e.g., the two-dimensional table in FIG. 7). In such a case, each sub-list of subscription identifiers may be associated with a dedicated first attribute value of the first attribute and dedicated second attribute value of the second attribute.

In some implementations, the activity-related data sets, the subscription profiles and the distribution statistics are generated in an initial learning phase under control of an initial learning function 230I (see FIG. 3). The data sets may be indicative of subscriber activities that have been monitored over successive periods of time during the learning phase. In such a variant, the subscriber activities associated with different sets of subscription identifiers may be monitored in different periods of time. With such a “sweeping”-type monitoring approach, the network event generation and network event reporting functions in the communication network domain 100 can be disburdened, in particular if for all (or a high percentage of) subscribers data sets are desired for subscriber profiling.

The different sets of subscription identifiers for the learning phase may be defined by a sampling algorithm receiving subscription identifiers as input and yielding a monitoring decision for a given period of time as output. The sampling algorithm may be configured to apply a hash function. If, for example, n+1 different periods of time 0 to n are defined, the hash function may map each subscription identifier (e.g., SUPI or IMSI) to exactly one of the numbers 0 to n, i.e., the associated period of time, for monitoring. If n=9, the hash function may simply output the last digit of the subscription identifier. Based on the available hardware capacity for monitoring and reporting, 10% of all subscribers will in this example be monitored at a time, e.g., for a time period of one day. The next day, another 10% of all subscribers will be monitored, and so on. Of course, the period of time could also be selected to be longer or shorter. If the period of time is one hour, the hash function may divide the subscriber set into 24 equal parts, and the actually monitored fraction of subscribers could randomly be distributed over one day while the total monitoring lasts several days (e.g., a week).

The hash function in some variants is locally (e.g., by individual NFs) applied within the communication network domain 100 based on monitoring control instructions received from the monitoring control apparatus 240. The monitoring control apparatus 240 may generate corresponding monitoring control instructions based on information 230J (see FIG. 3) provided by the initial learning function. As illustrated in FIG. 3, the information 230J may define a sampling rate, for example via a hash function. In the above example in which the hash function outputs the last digit of the subscription identifier, the sampling rate will be 10%. Evidently, the sampling rate can also be defined otherwise.

As said, there may be an initial learning phase to gather from the communication network domain 100 the network event information underlying the data sets to be processed for subscriber profile generation in step 402 of FIG. 4, and for generation of attribute distribution statistics in step 404 of FIG. 4. The list assembling step 406, on the other hand, may be performed during, or in preparation of, a subsequent operational phase to address a dedicated network analysis request (see function 230F in FIG. 3). The operational phase may comprise performing network monitoring based on the list of subscription identifiers.

In the following, more detailed aspects of the present disclosure will be presented. Those aspects may be implemented in the network system 10 of FIG. 1 and in particular by the subscriber activity correlator 220 and subscription identifier determination apparatus 230, for example in the context of the method embodiment described above with reference to FIG. 4.

### 1. Data Sets

A data set as provided by the subscriber activity correlator 220 is the smallest “atomic” piece of correlated information in the NM domain 200 (e.g., in SOC) that includes meaningful information related to subscriber activities. As explained above with reference to FIG. 1, such data sets can be derived from network events as collected by today's existing network analytics system, such as the Ericsson Expert Analytics (EEA) system. In some variants, a data set contains some, many or all the details of an individual (short) subscriber activity and, optionally, further activity-related information obtained by one or more of correlation, enrichment and aggregation (or similar processes).

In some variants, one or more (e.g., all) of the following items are collected and correlated per individual subscriber activity, which can be considered an individual “network transaction”, in the communication network domain for a particular data set:
1. Subscription identifier (e.g., SUPI or IMSI), sometimes also called User ID
2. Terminal device (e.g., User Equipment) ID (e.g., IMEI-TAC)
3. Start timestamp of activity (“epoch”)
4. Duration of activity (e.g., in seconds)
5. Geographical location(s) of the terminal device during the activity (e.g., cell-ID or Radio access technology, RAT, used)
6. Dimension block 1 values: enrichment for items 1 to 5
7. Activity type (e.g., service type)
8. Service quality KPI value(s)
9. Dimension block 2 values: service specific extra dimensions with their values, enrichment for items 7 and 8

Items 2 to 9 of the above list can be interpreted as attributes that can assume one of several attribute values. One data set typically only includes one dedicated attribute value per attribute. Item 1 is the subscription identifier. See also FIG. 5 for an exemplary structuring of the data sets.

As for item 7, in particular as to service types, the subscribers use a variety of services. Those services are provided by their terminal devices, the communication network domain 100 and external networks, such as the Internet, and include, but are not limited to the following service types:
Video streaming
Video conferencing
Video chat/video call
Voice call
Messaging
E-mail
Web browsing
File download
File upload
Location services
Presence
Software update
Social networking

As for item 8, service quality for each service can be measured by one or more KPIs (e.g., metrics in terms of Quality of Experience that indicate the subscriber perceived service quality). Some of these KPIs can be common for several service types, e.g., a downlink throughput KPI, which can be relevant for Web browsing, video streaming, file transfer, and several other service types. In many cases, though, the KPI is unique for a particular service, for example video stall ratio, which is relevant and can be computed for video streaming service only. The set of KPIs that can be incorporated in a particular data set include, but are not limited to the following metrics:
Downlink/uplink throughput of data traffic
Video quality
Video stall time ratio
Video initial buffering time
Session setup time
Session setup success ratio
Web page access time
Web page download time
Web page download success ratio
Downloaded-uploaded bytes
Voice quality
Call setup time
Call setup success ratio
Call drop ratio

As for item 9, parameters of atomic subscriber activities can be enriched by extra dimensions to enhance the informational content of the data sets. As an example, one or more of the following fields may be added as enrichment, based on data set items 1 to 5:
1. Subscription identifier- (User-ID-) based enrichment:
   1. Subscription type (plan type, plan name)
   2. Subscriber category (VIP, enterprise, group, private, etc.)
2. Terminal based enrichment:
   1. Device vendor
   2. Device model
   3. Device type (smartphone, tablet, stick, etc.)
   4. Device capability (HS-cat, LTE-cat, etc.)
   5. Screen size (inches)
3. Time specific enrichment of start timestamp:
   1. Day of week
   2. Weekend/weekday
   3. Hour of day
   4. Month
   5. Morning/Afternoon/Evening/Night
4. Location-based enrichment:
   1. Cell area type (rural, downtown, shopping mall, suburb, event hall, office area, etc.)
   2. Cell location type (indoor/outdoor)
   3. RAT (2G, 3G, 4G, 5G)
   4. RAN (e.g., cell) vendor
   5. Carrier

As for items 8 and 9, in addition to the enriched dimension set of item 6, the service types each can have further dimensions as well. In more detail, each service type can have a subset of dimensions that describe details related to service usage. These dimensions can be common for multiple service types. For example, the attribute “content provider” as dimension can be relevant both for web browsing and video streaming. However, in many cases the dimensions are service specific. The set of dimensions in regard to items 8 and 9 include, but are not limited to the following:
Content provider/service provider
Encryption type
Video resolution
Video bitrate
Radio conditions (signal strengths)
Congestion conditions (cell load)

Some attributes typically have discrete nominal attribute values (e.g., content provider may be a string, having a few hundred possible values, such as YouTube, Netflix, Google, Facebook, etc.). Other attributes such as radio conditions, for example reference signal received power (RSRP), reference signal received quality (RSRQ), channel quality indicator (CQI), can have numeric values. Each numeric values can be transformed, or binned, to a well-defined discrete attribute value (e.g., in case of the above radio condition cases: very poor, poor, acceptable, good, very good) to support the profile building.

An exemplary data set derived based on collected and correlated network events and supplemental enrichment can have a content as follows (wherein the parameter user-id corresponds to the subscription identifier, such as SUPI or IMSI):
[user-id=1234567890 (prepaid user, VIP user, unlimited plan), device-id=453786 (Apple, Iphone 7, smartphone, . . . ), start-ts=1618901475 (Tuesday, April, morning, 6 h, weekday), duration=5.2, location=cell-12345 (rural, Ericsson, 4G, outdoor, . . . ), Web browsing (content provider=CNN, encryption=none, radio conditions=good, cell load=moderate, . . . ), Web page download time=4 sec, downlink throughput=4 Mbps, . . . ]

### 2. Subscriber Profiles

Subscriber profiles may contain a model for each subscriber related to his/her behavior in the communication network. As explained above, the subscriber profiles are generated based on the data sets provided by the subscriber activity correlator 220 (see, e.g., FIGS. 1, 5 and 6). As such, a subscriber profile aggregates the individual subscriber activities over a sufficiently large time window (over which data sets have been continuously generated) to characterize the subscriber.

The subscriber profile may, at least partially, be a probabilistic model. As an example, the subscriber profile may contain for one or more activity-related attributes, or dimensions, a probability indication that the subscriber performs the given activity (attribute) in a certain way (attribute value). The probability indication may be determined from the data sets associated with a specific subscription identifier. The probability indication may be a ratio calculated over all pertinent data sets (see, e.g., FIG. 6 and the ratios indicated therein, such as 1, 0.6, 0.5, 0.4 and 0).

Another example: a subscriber typically has activity in the evening (80%) and some in the morning (20%). Therefore, the time-specific profile attributes will be as following: morning 0.2, afternoon 0, evening 0.8 and night 0. The same holds for all other dimensions, e.g., the same subscriber typically uses web browsing as a service (0.6), with some video streaming (0.3) and a little e-mail (0.1).

In one variant, the subscriber profile has the following key elements:
1. Subscription identifier/User ID (IMSI) [key]
   a. Subscription type (plan type, plan name)
   b. Subscriber category (VIP, enterprise, group, private, etc.)
2. Typical terminal(s)
   a. [(UE-ID-1, usage-ratio-1), . . . , (UE-ID-k, usage-ratio-k)], k=1 . . . 3
   Typically (mostly k=1), this vector shows the used devices with their relative usage ratio [in percentage] (e.g., based on usage time (usage frequency) or total bytes transferred)
   Example: k=1, UE-ID-1=57863444, usage-ratio-1=1
   b. [(UE-type-1, usage-ratio-1), . . . , (UE-type-k, usage-ratio-k)], k=1 . . . 3
   Typically (mostly k=1), this vector shows the used terminal types with their relative usage ratio [in percentage] (e.g., based on usage time (usage frequency) or total bytes transferred)
   Example: k=2, UE-type-1=smartphone, usage-ratio-1=0.9, UE-type-2=tablet, usage-ratio-2=0.1
   c. [(UE-vendor-1,usage-ratio-1), . . . , (UE-vendor-k, usage-ratio-k)], k=1 . . . 3
   Typically (mostly k=1), this vector shows the vendor of the used device with their relative usage ratio [in percentage] (e.g., based on usage time (usage frequency) or total bytes transferred)
   Example: k=1, UE-type-1=Apple, usage-ratio-1=1
   d. [(UE-model-1,usage-ratio-1), . . . , (UE-model-k, usage-ratio-k)], k=1 . . . 3
   Typically (mostly k=1), this vector shows the exact model of the used device with their relative usage ratio [in percentage] (e.g., based on usage time (usage frequency) or total bytes transferred)
   Example: k=1, UE-model-1=Apple iPhone 7, usage-ratio-1=1
3. Typical activity times
   a. Typical usage patterns (Time of Day) [morning-ratio, afternoon-ratio, evening-ratio, night-ratio]
   This vector shows the activity patterns of the user with respect to the part of the day with their relative usage ratio [in percentage] (e.g., based on usage time (usage frequency) or total bytes transferred)
   Example: [0.3,0.1,0.5,0.1]
   b. Weekday-weekend pattern [weekday-ratio, weekend-ratio]
   This vector shows the activity patterns of the user with respect to weekend/weekday with their relative usage ratio [in percentage] (e.g., based on usage time (usage frequency) or total bytes transferred)
   Example: [0.6,0.4]
   c. Day pattern [Monday-ratio, Tuesday-ratio, . . . , Sunday-ratio] (a vector of length k=7)
   This vector shows the per day activity patterns of the user with their relative usage ratio [in percentage] (e.g., based on usage time (usage frequency) or total bytes transferred)
   Example: [0.1,0.2,0.1,0.1,0.1,0.2,0.2]
   d. Daily pattern [0:00-ratio, 01:00-ratio, . . . , 23:00-ratio] (a vector of length k=24)
   This vector shows the per hour activity patterns of the user with their relative usage ratio [in percentage] (e.g., based on usage time (usage frequency) or total bytes transferred)
4. Typical locations
   a. Cell type [rural-ratio, city-ratio, . . . , shopping-mall-ratio] (a vector of length equal to the number of cell categories defined, e.g. k=10-20)
   This vector shows the activity patterns of the user per cell category, with their relative usage ratio [in percentage] (e.g., based on usage time (usage frequency) or total bytes transferred)
   b. Cell location type [indoor-ratio, outdoor-ratio]
   This vector shows the activity patterns of the user per indoor and outdoor cells, with their relative usage ratio [in percentage] (e.g., based on usage time (usage frequency) or total bytes transferred)
   c. RAT [2G-ratio, 3G-ratio, 4G-ratio, 5G-ratio]
   This vector shows the activity patterns of the user per radio access technology (RAT), with their relative usage ratio [in percentage] (e.g., based on usage time (usage frequency) or total bytes transferred)
5. Typically used service types/activity types
   a. [video-ratio, web-ratio, . . . , social-networking-ratio] (a vector of length equal to the number of service types/activity types defined or available in the network, e.g., k=10-20)
   This vector shows the activity patterns of the user per service or activity type, with their relative usage ratio [in percentage] (e.g., based on usage time (usage frequency) or total bytes transferred)
6. Typical dimension values related to the individual service types (see fields in for item 9 of the data sets)
   a. Content provider set [YouTube-ratio, Facebook-ratio, . . . ] (a vector of length equal to the number of content providers defined or available in the network for service or activity types where it is applicable (video, web), e.g., k=100-200)
   This vector shows the activity patterns of the user per service or content provider, with their relative usage ratio [in percentage] (e.g., based on usage time (usage frequency) or total bytes transferred)
   b. Radio conditions [excellent-ratio, good-ratio, average-ratio, poor-ratio, bad-ratio, . . . ] (a vector of length equal to the number of radio condition categories defined, e.g., k=5)
   This vector shows the activity patterns of the user with respect to the measured radio signal quality during the activity, with their relative usage ratio [in percentage] (e.g., based on usage time (usage frequency) or total bytes transferred)
   c. Congestion (cell load) conditions [heavy-ratio, normal-ratio, small-ratio, . . . ] (a vector of length equal to the number of congestion categories defined, e.g., k=5)
   This vector shows the activity patterns of the user with respect to the measured cell load during the activity, with their relative usage ratio [in percentage] (e.g., based on usage time (usage frequency) or total bytes transferred)
7. Activity intensity
   a. How active the subscriber is relatively?

### 3. Attribute Distribution Statistics

There is a further new element introduced in the NM domain 200, namely attribute distribution statistics that can be expressed as a set of attribute distribution statistics tables (see FIG. 7) related to subscriber activity and generated from the subscriber profiles. Of course, the attribute distribution statistics could also be expressed through other means than tables, for example using mappings or functions.

The aim of the attribute distribution statistics is to understand the overall distribution of attribute, or dimension, values within the whole subscriber base, and to facilitate the proper sampling of subscription identifiers in the list assembling step 406.

In some variants, the attribute distribution statistics contain 1-dimensional, 2dimensional, 3-dimensional, or higher dimensional tables. Such tables can be created based on operator preference (e.g., as to how many dimension types to treat simultaneously and as to the required attribute combinations that are interesting for gaining analytics insights).

### 1-Dimensional Tables

For each selected attribute for later analysis, and for each available value of the attribute, the distribution statistics table indicates how many of the subscribers are having that particular value in their subscriber profile (see, e.g., upper two tables in FIG. 7).

An example: there are 1 million total subscribers. Two dimension types are selected for two separate 1-dimensional tables: terminal type and activity time

The attribute terminal type has four available values: Tablet, Smartphone, IoT, Wearable device. The resulting 1-dimensional distribution table will look as follows:
Tablet=100000, Smartphone=800000, IoT=50000, Wearable=50000.

This means that the 80% of the subscriber population uses smartphones, and whatever analytics request will need to be answered, it has to be ensured that 80% of the sampled subscribers have smartphones. If some subscribers use multiple terminal types (i.e., if there is an overlap of the associated attribute values in a given subscriber profile), this can will be taken into account in various ways. For example, in this case not a “1” will be counted for certain attribute values, but several attribute values will be incremented, so that the total value will be 1 (see subscriber profiles for SUB ID1 and SUB ID2 in FIG. 6).

The attribute activity time may also have four available values: morning, afternoon, evening, night, with the following inferred distribution table:
morning=100000, afternoon=300000, evening=550000, night=50000.

### 2-Dimensional Tables

It may in some cases be needed to have distribution statistics for multiple dimensions, to cover the multidimensional aspects of the subscriber distribution (see, e.g., lower table in FIG. 7).

An example: there are 1 million subscribers. One 2-tuple of attributes is selected to form a 2-dimensional distribution table, namely terminal type and activity time. As seen in the above 1-dimensional example, each of these attributes has 4 available values, so the 2-dimensional distribution table will have 16 elements, for the following combinations: tablet-morning, tablet-afternoon, tablet-evening, tablet-night, smartphone-morning, . . . , wearable device-night. The values for each entry in the table are inferred, resulting their sum to be 1 million.

The 2-dimensional entries show how many subscribers from the tablet users of 100000 and the morning users of 100000, use their tablets in the morning, say tablet-morning=10000.

Evidently, the 2-dimensional case can be generalized to three and more dimensions.

### Inferring the Distribution Statistics for Each Attribute

When the subscriber profiles have been computed, the attribute distribution statistics may be generated as follows. It will be assumed that there exists an (e.g., operator-defined) set of attribute distribution statistics tables that may initially be empty. The attribute distribution statistics calculation process selects a particular statistics distribution table and then parses the subscriber profiles (as learnt in the learning phase) to count each subscriber into the appropriate attribute value category

1-dimensional tables are the simplest case (see upper two tables in FIG. 7). The attribute distribution statistics calculation process considers each available attribute value of the given 1-dimensional table and counts each subscriber, based on the associated subscriber profile, into the appropriate table category. In some cases, probability values (e.g., ratios) are used from the profiles, so if the subscriber is falling into categories of several available values of the attribute, this can be taken into account.

Assume, as an example, that there are 1 million subscribers. Assume further that there is a 1-dimensional table for the “terminal type” attribute that can assume four different attribute values (see the upper table in FIG. 7). If a subscriber always uses the same terminal type and is thus having a value of “1” in his/her profile for the given attribute value (see, e.g., the subscriber profiles in FIG. 6), the associated table field (e.g., “smartphone”) is incremented by 1 for each subscriber profile matching that field. If, on the other hand, the subscriber uses for example in 80% of all cases his/her smartphone, and in 20% a tablet, these two categories are incremented by 0.8 and 0.2, respectively. The final distribution table entries will sum up to 1 million.

For 2-dimensional tables (see lower table in FIG. 7), a similar process is applied as discussed for the one-dimensional case, with the extension that values of multiple attributes per subscriber are multiplied to give the weight for each subscriber.

Assume, as an example, that for the two attributes terminal type and activity time there exist 16 table fields, or categories, in total. Consider a subscriber profile with the following subscriber profile entries: morning=0.2, afternoon=0, evening=0.7, night=0.1 and tablet=0.2, smartphone=0.8. This subscriber profile will increment the following distribution statistics table fields: morning-tablet with 0.04, evening-tablet with 0.14, night-tablet with 0.02, morning-smartphone with 0.16, evening-smartphone with 0.56 and night smartphone with 0.08, and these entries naturally sum up to 1. Certain combinations may be neglected (e.g., that the tablet is always used in the morning) is neglected, due to the exploding complexity of the subscriber profiles. The profiles are always 1-dimensional.

For k-dimensional tables, the 2-dimensional case can be generalized.

The numbers and types of stored distribution statistics tables is an operator choice, depending also on the available computation resources. Evidently, with k=2 and above the number of table fields will increase exponentially. Nonetheless, the numbers and types of stored distribution statistics tables is the “enabler” to efficiently answer network analysis requests. The types of network analysis requests that can be answered strongly depends on the number and type of distribution statistics tables stored. The network analysis requests may also be given a “dimensionality” depending on the number of attributes involved to answer a given request. As for “1-dimensional” network analysis requests, all attributes can be covered by distribution statistics tables, since the number of cases (and the size of associated 1-dimensional distribution statistics tables) is small. To address “2-dimensional” network analysis requests, still almost all pairs can be covered, since the combinations are still relatively small, e.g., (subscriber-type, terminal-type), (terminal-type, activity-type), etc. In regard of “3-dimensional” network analysis requests, a selection of pre-defined distribution statistics tables is based on considering the focus of the typical analytics questions, such as (subscriber-type, terminal-type, activity-type), (subscriber-type, device-model, daily-activity pattern), etc.

### 3. Assembling Subscription Identifier List/Subscriber Sampling

Whenever a SOC-triggered network analysis request emerges, and analytics information is required, one or more attributes (with associated attribute values) are involved in the request. Moreover, one or more KPIs of interest may be communicated in the network analysis request, such as video service quality.

As a few examples, the operator may be interested in one or more of the following attributes, wherein attribute values of interest in brackets:
Video service quality in general [video]
Video service quality in peak hours (evening) [video-evening]
Video service quality for Apple devices and Ericsson base stations [video-apple-ericsson]
Video service quality for Netflix as service provider and for tablet users [video-netflix-tablet]

The technique presented herein enables the selection of a representative subscriber set (i.e., a list of associated subscription identifiers) to answer the network analysis request and to provide corresponding monitoring control instructions for that subscriber set and the associated KPI(s) of interest. Evidently, the answer has to be correct for the whole (e.g., mobile) network, and shall not introduce any bias or error.

### Stratified Sampling

Stratified sampling, as proposed herein, is a probability-based sampling procedure that may be performed in the context of the list assembling step 406 of FIG. 4 (see also sampling function 230E in FIG. 3). For stratified sampling, the target population of subscribers has previously been separated into (typically mutually exclusive, homogeneous) segments (strata) as defined by attribute values of a given attribute (see steps 402 and 404 of FIG. 4). Then subscribers are sampled, or selected, for each segment (stratum) individually, and corresponding sub-lists of subscription identifiers are generated. The sub-lists for the various strata are then combined into a single list of subscription identifiers.

Stratified sampling may in some variants include the following steps:
1. Define the target population of subscribers (e.g., select a sub-set of subscriber profiles out of a larger set of subscriber profiles or select all available subscriber profiles).
2. Identify stratification attribute(s) and determine the strata (i.e., attribute values) to be used. As said, the stratification attribute(s) and the associated attribute values may be defined in the network analysis request.
3. Divide pool of subscription identifiers (corresponding to the target population defined in step 1) into strata, or sets, based on the attribute values defined in step 2. To this end, the subscriber profiles (and associated subscription identifiers) need to be identified (i.e., selected) that contain a particular attribute value of interest. The resulting strata can be independent and mutually exclusive subsets of the population (the case of overlapping “strata” will be discussed below).
4. Determine the sample size for each stratum. In some variants, for a given attribute, the distribution of the associated attribute values across the various strata determines the type of stratified sampling (i.e., list population) algorithm that is implemented and, thus, the sample size (i.e., cardinal number of the associated sublist of subscription identifiers) per stratum. Exemplary algorithms include proportionate stratified sampling or one of the various types of disproportionate stratified sampling.
5. Randomly select the targeted number of elements (i.e., the sample size) as determined in step 4 from each stratum of subscription identifiers as obtained in step 3. In this way, sub-lists of subscription identifiers are populated from the “strata” of subscription identifiers, and entirety of sub-lists thus obtained constitutes the list of subscription identifiers as obtained in step 406 of FIG. 4.

There are two major subtypes of sampling algorithms: proportionate stratified sampling and disproportionate stratified sampling that can be applied by the sampling function 203E of FIG. 3. Disproportionate stratified sampling has various subcategories.

### Proportionate Stratified Sampling

In proportionate stratified sampling, the number of elements (i.e., subscription identifiers) allocated to the various strata (sub-lists) is proportional to the representation of the strata in the target population. That is, the size of the sample drawn from each stratum (as defined by a particular attribute value) is proportional to the relative size of that stratum in the target population.

As regards, usage considerations, proportionate stratified sampling can be used to estimate the target population's parameters. One example is a direct comparison of the performance of different RAN vendor-terminal type pairs (e.g., to make a detailed analysis within a RAN vendor-terminal type-related list of subscription identifiers cardinal number of that list is sufficient). Such an approach typically requires less samples compared to a simple random sampling approach without prior subscriber profiling, but still may not yield enough samples for low-traffic rare-terminal pairs. In such, and other, cases, disproportionate stratified sampling may be applied.

### Disproportionate Stratified Sampling

Disproportionate stratified sampling is a stratified sampling approach in which the number of elements sampled (i.e., selected) for each stratum is not proportional to their representation in the total population. In order to estimate certain population parameters, the population composition can be used as weight(s) to compensate for the disproportionality in the sample. However, for some network analysis requests, disproportionate stratified sampling may be more appropriate than proportionate stratified sampling.

Disproportionate stratified sampling may be broken into three subtypes based on the purpose of allocation that is implemented. The purpose of the allocation could be to facilitate within-strata analyses, between-strata analyses, or optimum allocation. If disproportionate allocation is used, weighting is helpful to make accurate estimates of population parameters. Disproportional sampling will result in biased data, therefore “global level” population parameters cannot be estimated from this data. In order to be able to compensate for such a bias, the data should be transformed back (i.e., weighted) to represent the original distribution of the data that is stored in the subscriber profile database 230B. There are well known mathematical and statistical methods for this transformation.

### Disproportionate Allocation for Within-Strata Analyses

The purpose of a network analytics question may require a researcher to conduct detailed analyses within the strata of an attribute or attribute combination of interest. If using proportionate stratification, the sample size of a stratum can become very small, so it may be difficult to meet the objectives of the analyses. One option variant of a disproportionate sampling thus would be to oversample the low-populated strata (e.g., by selecting the same number of subscription identifiers per sample or by selecting a number of subscription identifiers that is inversely proportional to the size of the respective stratum).

As for usage considerations, disproportionate allocation for within-strata analyses can in the present example be used for a detailed analysis within a RAN-vendor terminal-type pair (e.g., to identify the root cause of an interworking problem), but cannot be used to estimate population parameters or compare the different RAN-vendor pairs along population related parameters (e.g., number of impacted subscribers) without weighting. Since disproportionate sampling does not preserve the “global level” statistics of the data, it cannot be used for an estimation of population parameters (e.g., compare the number of impacted subscribers for the different RAN-vendor pairs), only for “within-strata” analysis (e.g., to identify the root cause of an inter-working problem for a given RAN-vendor terminal-type pair). On the other hand, the disproportionate sampling technique will ensure the necessary sample size even for rare RAN-vendor terminal-type pairs.

### Disproportionate Allocation for Between-Strata Analyses

The purpose of a study may require a researcher to compare strata to each other. If this is the case, a sufficient number of subscription identifiers must be selected for each stratum.

A researcher may desire to maximize the sample size for each stratum. In such a case, equal allocation (also referred to as “balanced allocation” and “factorial sampling”) may be appropriate. A researcher may thus seek to select an equal number of elements for each stratum.

As for usage considerations, this technique can be used to compare different RAN vendor-terminal type pairs even for rare RAN vendor-terminal type combinations if the comparison parameter of interest for the network analytics question (e.g., a certain KPI) does not relate to the population (e.g., can be used for throughput comparison but cannot used for comparison of the number of impacted subscribers).

### Optimum Allocation

Optimum allocation is designed to achieve even greater overall accuracy than that achieved using proportionate stratified sampling. It sets the sample size of the different strata, taking into account two important aspects of doing research: costs and precision. The sampling fraction varies according to the costs and statistical variability within the various strata.

Homogeneous strata with a smaller sample size can have the same level of precision as heterogeneous strata with a larger sample size. Applying this principle, it may be useful to make the number of subscription identifiers selected for each stratum directly related to the standard deviation of the variable (i.e., attribute) of interest in the stratum. Moreover, taking into account data collection costs, the higher the data collection costs of a stratum, the lower the targeted sample size.

As for usage considerations, this approach can further reduce the number of required samples for the same network analytics accuracy level by considering certain statistical measure (e.g., standard deviation). On the other hand, the analysis of the data collected is more complex. If, for example, there is a “stable” RAN-vendor terminal-type pair, with low standard deviation of the throughput KPIs, it will be sufficient to take less samples for the same accuracy.

Compared to simple random sampling, stratified sampling has greater ability to make inferences within a stratum and comparisons across strata. Moreover, stratified sampling has slightly smaller random sampling errors for samples of same sample size, thereby requiring smaller sample sizes for the same margin of error, and takes advantage of knowledge the researcher has about the population (i.e., in terms of subscriber profiles etc.). Therefore, stratified sampling methods can overcome the drawbacks of the simple random sampling.

In case of overlapping groups there are two options: one is to modify stratum definition (e.g., to consider the most typical or probable location and classify user locations into city/rural categories based on the typical behavior), the other one is to use proportional stratum membership based on the probabilities in the subscriber profile, as described above.

As has become apparent from the above description of exemplary embodiments, the subscriber profiling approach presented herein allows a reduction of the number of subscribers to be monitored to solve a specific network analysis task. The information underlying the subscriber profiles can be obtained in an initial learning phase by cost-efficient sweeping techniques. The analysis of distribution statistics helps to understand the global activity patterns in a communication network. As a result, highly accurate analytics information can be obtained without leaving a massive monitoring footprint in the communication network. Also uneven distributions of samples can easily be addressed (e.g., compared to pure random sampling without prior subscriber profiling). As opposed to spotlight approaches, the entire communication network can be covered. Moreover, network analysis requests can be answered promptly in near real-time.

1. A method of determining subscription identifiers for subscriber monitoring in a communication network, wherein a plurality of data sets is provided and each data set associates, for a particular subscriber activity in the communication network, a subscription identifier with one or more activity-related attributes each having a dedicated attribute value, the method comprising:
processing the data sets to generate subscriber profiles, wherein each subscriber profile associates a subscription identifier with, for at least a first attribute, an attribute value or an attribute value distribution as derived from the data sets associated with the subscription identifier;
generating, from the subscriber profiles, attribute distribution statistics indicative of an occurrence of attribute values for at least the first attribute across the subscribers for which data sets have been processed; and
assembling, based on the distribution statistics and the subscriber profiles, a list of subscription identifiers for which subscriber activities are to be monitored for a network analysis relating to at least the first attribute.

2. The method of claim 1, wherein
the list of subscription identifiers comprises at least two sub-lists of subscription identifiers, wherein each sub-list is associated with a dedicated attribute value of at least the first attribute.

3. The method of claim 2, comprising
selecting, for a particular attribute value of at least the first attribute, the subscriber profiles matching that attribute value, wherein the respective sub-list of subscription identifiers is populated by at least some of the subscription identifiers associated with the selected subscriber profiles.

4. The method of claim 3, wherein
a cardinal number of the populated sub-list of subscription identifiers is less than a cardinal number of the selected subscriber profiles.

5. The method of claim 4, comprising
executing a random-based population algorithm to populate the sub-list of subscription identifiers such that the cardinal number of the populated sub-list is less than the cardinal number of the selected subscriber profiles.

6. The method of claim 2, wherein
each sub-list has a respective cardinal number that depends on a relative or absolute occurrence of the respective attribute value as defined in the attribute distribution statistics.

7. The method of claim 6, wherein
the cardinal number of a given sub-list is proportional to the relative or absolute occurrence of the respective attribute value as defined in the attribute distribution statistics.

8. The method of claim 6, wherein
the cardinal number of a given sub-list is relatively higher if the relative or absolute occurrence of the respective attribute value as defined in the attribute distribution statistics is relatively lower.

9. The method of claim 6, wherein
the cardinal number of a given sub-list depends on a statistical measure derived from the attribute distribution statistics.

10. The method of claim 9, wherein
the statistical measure is a standard deviation.

11. The method of claim 6, wherein
the cardinal number of a given sub-list is inversely proportional to the relative or absolute occurrence of the respective attribute value.

12. The method of claim 2, wherein
each sub-list has the same cardinal number.

13. The method of claim 1, wherein
one or more of the subscriber profiles associate a single attribute value with at least the first attribute.

14. The method of claim 1, wherein
one or more of the subscriber profiles associate two or more different attribute values with at least the first attribute. 15-17. (canceled)

18. The method of claim 1, wherein
at least some of the subscriber profiles associate the respective subscription identifier with a first attribute value, or a first attribute value distribution, for the first attribute and a second attribute value, or a second attribute value distribution, for the second attribute; and wherein
the attribute distribution statistics are indicative of a combined occurrence of the respective attribute value for at least the first attribute and the second attribute across the subscribers for which data sets have been processed.

19. (canceled)

20. The method of claim 1, wherein
the data sets are obtained for more than 50%, and optionally all of the subscriber activities in the communication network during a particular period of time.

21. The method of claim 1, wherein
the data sets are indicative of subscriber activities that have been monitored over successive periods of time, wherein the subscriber activities of different sets of subscription identifiers are monitored in different periods of time.

22. The method of claim 21, wherein
the different sets of subscription identifiers are defined by a sampling algorithm receiving subscription identifiers as input and yielding a monitoring decision for a given period of time as output.

23. The method of claim 22, wherein
the sampling algorithm is configured to apply a hash function.

24. The method of claim 1, comprising
obtaining further data sets based on monitoring for the subscription identifiers included in the list; and
updating the subscriber profiles based on the obtained further data sets.

25.-36. (canceled)
